(19) United States
(12) Patent Application Publication
(10) Pub. No.: US 2026/0024464 A1
(43) Pub. Date: Jan. 22, 2026

(54) SELF-SEALING CLEARVIEW MEDICAL PROCEDURE MANNEQUIN

(71) Applicants: Atiquer Rahman, Clifton, NJ (US); Kulsuma Akhter, Clifton, NJ (US)

(72) Inventors: Atiquer Rahman, Clifton, NJ (US); Kulsuma Akhter, Clifton, NJ (US)

(21) Appl. No.: 19/050,328

(22) Filed: Feb. 11, 2025

Related U.S. Application Data
(60) Provisional application No. 63/672,872, filed on Jul. 18, 2024.

(51) Int. Cl. G09B 23/28; G09B 23/30

(52) U.S. Cl. CPC G09B 23/285; G09B 23/30

(57) ABSTRACT

The present invention is a procedure simulator mannequin device. The device is constructed from a transparent self-sealing material, such as rubber or silicone, that mimics the texture and elasticity of human skin. The mannequin features a plurality of internal cavities filled with color-coded fluids to simulate various bodily fluids, such as oxygen-rich blood, oxygen-poor blood, and other bodily fluids. The device includes replenishable and replaceable color-coded fluids that react to medical procedures by providing visual feedback.

### CROSS-REFERENCE TO RELATED APPLICATION

The present application claims priority to, and the benefit of, U.S. Provisional Application No. 63/672,872 which was filed on Jul. 18, 2024, and is incorporated herein by reference in its entirety.

### FIELD OF THE INVENTION

The present invention generally relates to medical training mannequins. More specifically, the invention relates to a transparent procedure mannequin designed to enhance medical training by enabling users to observe internal anatomical structures and simulate real-time physiological responses during procedures. The mannequin comprises a transparent or translucent (i.e., clear view) body made of rubber or silicone, simulating the texture and elasticity of human skin and provides full visibility of internal components. The mannequin includes internal cavities filled with color-coded fluids to represent various replaceable and replenishable bodily fluids and artificial human body organs and structures that facilitate the practice of medical procedures. Accordingly, the present disclosure makes specific reference thereto. Nonetheless, it is to be appreciated that aspects of the present invention are also equally applicable to other like applications, devices, and methods of manufacture.

### BACKGROUND

By way of background, medical professionals require hands-on training to perform medical procedures before treating real patients. Traditionally, medical mannequins have been used in training environments to simulate human anatomy and enable students to practice procedures such as injections, suturing, incisions (i.e., via a scalpel or blade), and/or surgeries. However, traditional medical procedure training mannequins are constructed from opaque or solid materials, preventing trainees from visualizing internal structures and the effects of their procedures in real-time. The lack of visual feedback makes it difficult for students to understand the impact of their actions on the internal artificial human body organs and structures of the mannequins. Moreover, existing mannequins do not adequately simulate real-time physiological responses of organs and tissues, which limits their usefulness in preparing trainees for actual clinical conditions. Individuals desire an improved mannequin that addresses the limitations of the traditional mannequins by providing better visualization, enhanced interactivity, and real-time simulation of internal organ responses.

Therefore, there exists a long-felt need in the art for an advanced medical training mannequin that provides a clear view of internal anatomical structures during procedures. There is a long-felt need for a mannequin that enables medical professionals and students to directly observe the effects of medical procedures. Further, there is a long-felt need for a mannequin that enables for repeated use. Finally, there is a long-felt need for a durable, self-scaling mannequin that can withstand repeated needle insertions (i.e., sharp instrument penetration), incisions, (i.e., sharp instrument penetration), and other invasive procedures without significant degradation.

The subject matter disclosed and claimed herein, in one embodiment, comprises a clear view (i.e., clearview) procedure mannequin device specifically designed to address the limitations of traditional medical training mannequins. The mannequin is constructed from a transparent or translucent material, such as rubber or silicone, that mimics the texture and elasticity of human skin while enabling full visibility of internal anatomical structures. The mannequin includes a plurality of internal cavities that can be filled with different color fluids to simulate various types of bodily fluids, such as oxygen-rich blood, oxygen-poor blood, and other fluids. Additionally, the mannequin features replaceable and replenishable fluids.

In this manner, the ‘clearview’ procedure mannequin device of the present invention accomplishes all of the foregoing objectives and provides medical professionals and students with an enhanced, realistic training solution for training and medical education. The device has a transparent construction that enables users to observe internal processes in real-time.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a procedure mannequin device for medical training. The procedure mannequin device comprises a body made of a transparent material, wherein the material is configured to mimic the texture and elasticity of human skin and is capable of being pierced by a needle to simulate skin punctures. A plurality of internal cavities are disposed within the body, each of the plurality of internal cavities is configured to hold different color fluids to represent bodily fluids, wherein the color fluids include a first color fluid representing oxygen-rich blood, a second color fluid representing oxygen-poor blood, and a third color fluid representing other bodily fluids. A plurality of artificial human body organs are disposed within the body, each of the plurality of artificial human body organs is made from a material replicating the structure and position of real human organs.

In another aspect, a medical procedure mannequin device is disclosed. The device comprises a body made of a transparent or translucent self-sealing material capable of being pierced by a needle, simulating skin punctures, and visually exposing internal anatomical structures (i.e., internal components) for precision training. A plurality of artificial human body organs (i.e., internal components) is disposed within the body. A plurality of internal fluid cavities are configured to represent real bodily fluids, the internal fluid cavities being configured to hold and circulate fluids of different colors to simulate various types of blood and other bodily fluids.

In another embodiment, a method of simulating medical procedures using a procedure mannequin device is disclosed. The method includes the steps of providing a procedure mannequin comprising a body made of transparent or translucent material capable of being pierced by a needle, a plurality of internal cavities configured to hold different color fluids to simulate bodily fluids and a plurality of artificial human body organs, filling the internal cavities with fluids of different colors to simulate various types of bodily fluids, including red fluid for oxygen-rich blood, blue fluid for oxygen-poor blood, and yellow fluid for other bodily fluids, performing a medical procedure on the procedure mannequin, including inserting a needle or making an incision in the body of the mannequin.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of ‘clearview’ procedure mannequin device of the present invention in accordance with the disclosed structure; and

FIG. 2 illustrates a perspective view showing different components available in the chest area of the mannequin in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an advanced medical training mannequin that provides a clear view of internal anatomical structures during procedures. There is a long-felt need for a mannequin that enables medical professionals and students to directly observe the effects of medical procedures. Further, there is a long-felt need for a mannequin that enables for repeated use. Finally, there is a long-felt need for a durable, self-sealing mannequin that can withstand repeated needle insertions (i.e., sharp instrument penetration) and other invasive procedures without significant degradation.

The present invention, in one exemplary embodiment, is a medical procedure mannequin device. The device comprises a body made of a transparent or translucent self-scaling material capable of being pierced by a needle, simulating skin punctures, and visually exposing internal anatomical structures for precision training. A plurality of artificial human body organs is disposed within the body, each organ is configured to react to medical procedures by providing visual feedback. A plurality of internal fluid cavities are configured to simulate real bodily fluids, the internal fluid cavities being configured to hold and circulate fluids of different colors to simulate various types of blood and other bodily fluids.

Reference will now be made in detail to the present preferred embodiments of the invention, examples of which are illustrated in the accompanying drawings. Wherever possible, the same reference numerals are used in the drawings and the description to refer to the same or like parts.

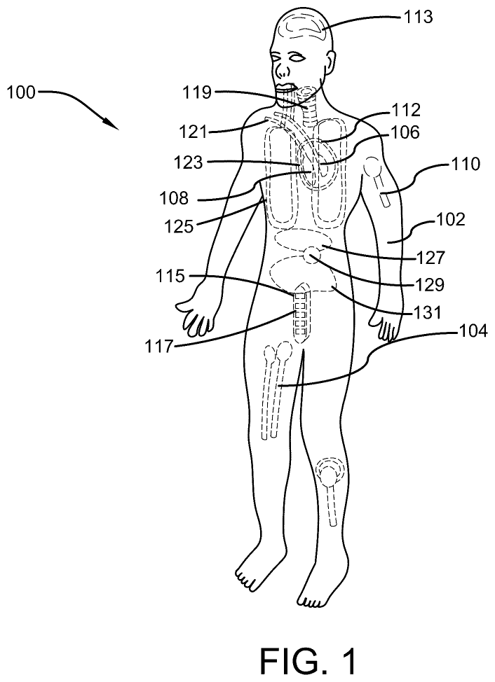

Referring initially to the drawings, FIG. 1 illustrates a perspective view of ‘clearview’ procedure mannequin device of the present invention in accordance with the disclosed structure. The ‘clearview’ procedure mannequin device 100 of the present invention is designed to help medical professionals and students practice various medical procedures. The mannequin is constructed from a durable, transparent rubber or silicone material and is configured to mimic texture and elasticity of human skin while providing full visibility of internal anatomical structures. More specifically, the ‘clearview’ procedure mannequin device 100 includes a body 102 made of a transparent (i.e., clear) or translucent material such as rubber or silicone. The material is flexible, durable, and capable of being pierced by needles such as injections, fluid or blood draws, incisions (i.e., via a scalpel or blade), and/or suturing to simulate skin punctures such as in medical treatments. The transparency of the material enables users to visually monitor internal components and procedures in real-time, thus improving precision during treatments. The rubber or silicone material is a self-scaling material for providing extended use without degradation of the mannequin's functionality.

The mannequin 100 includes a plurality of internal cavities 104 filled with different color fluids 106, 108, 110. A first color fluid 106 is preferably in a first color such as red to indicate blood flowing the corresponding cavity. A second color fluid 108 is preferably in a second color such as blue to indicate oxygen-poor blood and a third color fluid 110 is in a third color such as yellow to indicate bodily fluids in the corresponding cavity. The different color fluids 106, 108, 110 enhances the realism of procedures like blood draws, IV insertions, and/or surgical incisions (i.e., via a scalpel or blade). Each cavity of the plurality of internal cavities 104 is designed to be refilled or replaced (i.e., replenishable) with the color fluids 106, 108, 110, thereby enabling users to continuously reuse the mannequin during extended training sessions. It is to be appreciated that the plurality of color fluids are selectively replenishable using a large capacity syringe having a long needle for insertion into the mannequin 100.

The mannequin 100 includes a plurality of artificial human body organs 112 therein and the artificial human body organs 112 are preferably made from plastic or similar materials that replicate the structure and position of real human organs. The organs 112 may include the brain 113, bone 115, spinal column 117, trachea 119, vessels 121, heart 123, lungs 125, liver 127, stomach 129, intestines 131, and others depending on the specific training needs. All of the fluids are replaceable and replenishable, making the mannequin 100 highly adaptable and cost-effective for long-term educational use. The piercing can be done through different organs to simulate medical procedures such as fluid removal, intravenous insertions, biopsies, or minor surgeries.

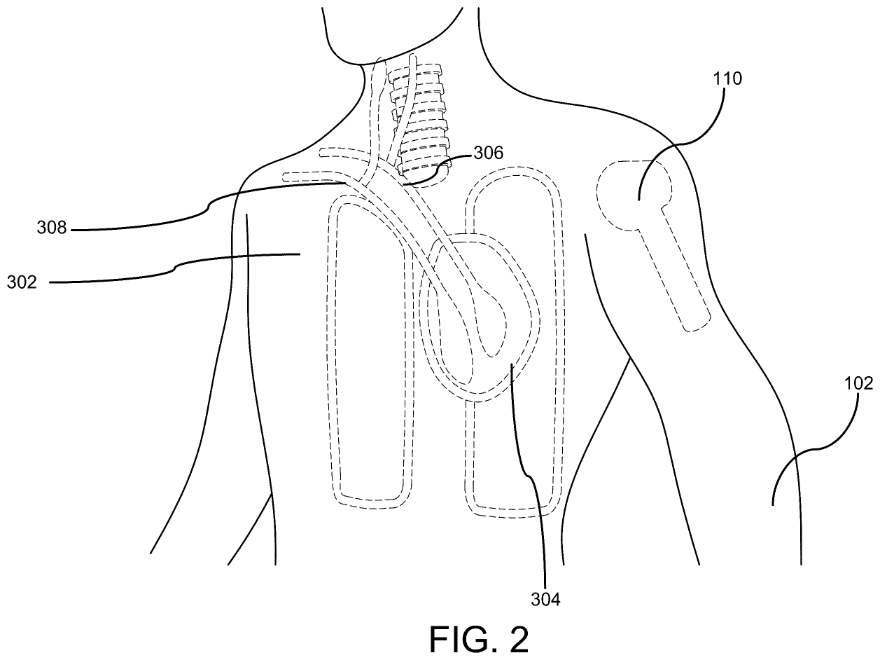

FIG. 2 illustrates a perspective view showing different components available in the chest area of the mannequin in accordance with the disclosed structure. As illustrated, in the chest area 302, the mannequin 100 includes a heart 304 and a plurality of arteries 306, 308 carrying pure and impure blood respectively. Other cavities including bodily fluids 110 are also included in the chest area 302. It should be noted that the mannequin 100 has a closed-loop fluid mechanism where the internal fluids are reused during operation of the mannequin. The device 100 is adapted to simulate various bodily fluids such as arterial blood, venous blood, or cerebrospinal fluid, to expand the range of medical procedures that can be practiced on the mannequin.

Different internal organs of the mannequin of different embodiments represent different pathological conditions, such as tumors, scar tissue, or organ failure, enabling users to practice procedures in different medical contexts. Further, the organs react similarly to real organs in different medical conditions imposed on the mannequin of different embodiments of the present invention.

The transparent design of the mannequin of different embodiments enables trainees and professionals to clearly observe the internal workings of the mannequin during a procedure, enabling for increased precision in techniques such as fluid removal, intravenous insertions, biopsies, or minor surgeries.

The transparent self-sealing medical procedure mannequin 100 can be used in medical schools, hospitals, and simulation centers for students and medical professionals for comprehensive training in a controlled environment without the need for live patients. The device can also be used to practice advanced techniques and new medical devices trial.

In one embodiment of the present invention, the procedure mannequin device is used for simulating medical procedures. The method includes the steps of providing a procedure mannequin comprising a body made of transparent or translucent material capable of being pierced by a needle, a plurality of internal cavities configured to hold different color fluids to simulate bodily fluids, a plurality of artificial human body organs, filling the internal cavities with fluids of different colors to simulate various types of bodily fluids, including red fluid for oxygen-rich blood, blue fluid for oxygen-poor blood, and yellow fluid for other bodily fluids, performing a medical procedure on the procedure mannequin, including inserting a needle or making an incision in the body of the mannequin, and providing feedback to the user based on the fluid flow and interaction with the artificial human body organs.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “'clearview' medical procedure mannequin”, “transparent self-scaling medical procedure mannequin”, “medical procedure mannequin device”, “mannequin”, and “device” are interchangeable and refer to the transparent self-sealing medical procedure mannequin 100 of the present invention.

Notwithstanding the foregoing, the transparent self-scaling medical procedure mannequin 100 of the present invention can be of any suitable size and configuration as is known in the art without affecting the overall concept of the invention, provided that it accomplishes the above-stated objectives. One of ordinary skill in the art will appreciate that the transparent self-sealing medical procedure mannequin 100 as shown in the FIGS. are for illustrative purposes only, and that many other sizes and shapes of the transparent self-sealing medical procedure mannequin 100, and other variations of positioning of internal organs and structures are well within the scope of the present disclosure. Although the dimensions of the transparent self-sealing medical procedure mannequin 100 are important design parameters for user convenience, the transparent self-sealing medical procedure mannequin 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mannequin device for simulating medical procedures comprising:
a mannequin body;
a plurality of internal cavities;
a plurality of color fluids; and
a plurality of internal components;
wherein said mannequin body covered by a flexible material;
wherein said flexible material surrounding said plurality of internal cavities and said plurality of internal components;
wherein said flexible material is penetrable by a sharp instrument;
wherein said sharp instrument is selected from the group consisting of a needle, a scalpel, and a blade; and
further wherein said flexible material is self-sealing after removing said sharp instrument.

2. The mannequin device for simulating medical procedures of claim 1, wherein said flexible material is transparent silicone for visually monitoring said plurality of internal components.

3. The mannequin device for simulating medical procedures of claim 1, wherein said flexible material is translucent silicone for visually monitoring said plurality of internal components.

4. The mannequin device for simulating medical procedures of claim 2, wherein said flexible material simulates skin for practicing medical treatments.

5. The mannequin device for simulating medical procedures of claim 4, wherein said medical treatments are selected from the group consisting of a fluid removal, a blood draw, an IV insertion, and a surgical incision.

6. The mannequin device for simulating medical procedures of claim 5, wherein a first color fluid of said plurality of color fluids is a red color to simulate oxygen-rich blood.

7. The mannequin device for simulating medical procedures of claim 6, wherein a second color fluid of said plurality of color fluids is a blue color to simulate an oxygen-poor blood.

8. The mannequin device for simulating medical procedures of claim 7, wherein a third color of said plurality of color fluids is a yellow color to simulate a body fluid.

9. The mannequin device for simulating medical procedures of claim 5, wherein said plurality of color fluids are selectively replenishable.

10. The mannequin device for simulating medical procedures of claim 9, wherein said plurality of color fluids are replaceable.

11. The mannequin device for simulating medical procedures of claim 10, wherein said plurality of artificial human body organs are selected from the group consisting of a brain, a bone, a spinal column, a trachea, a vessel, a heart, a lung, a liver, a stomach, and an intestine.

12. A mannequin device for simulating medical procedures comprising:
a mannequin body;
a plurality of internal cavities;
a plurality of color fluids; and
a plurality of internal components;
wherein said mannequin body covered by a flexible material;
wherein said flexible material surrounding said plurality of internal cavities and said plurality of internal components;
wherein said flexible material is penetrable by a sharp instrument;
wherein said sharp instrument is selected from the group consisting of a needle, a scalpel, and a blade; and
further wherein said flexible material is self-sealing after removing said sharp instrument.

13. The mannequin device for simulating medical procedures of claim 12, wherein at least one of said plurality of internal components trigger changes in at least one of said plurality of color fluids based on placement of said sharp instrument.

14. The mannequin device for simulating medical procedures of claim 12 further comprising haptic sensing for providing real time tactile feedback.

15. The mannequin device for simulating medical procedures of claim 14, wherein said flexible material is transparent silicone for visually monitoring said plurality of internal components.

16. The mannequin device for simulating medical procedures of claim 15, wherein said medical treatments are selected from the group consisting of fluid or blood draw, an IV insertion, and a surgical incision.

17. The mannequin device for simulating medical procedures of claim 16, wherein said plurality of color fluids are selectively replenishable.

18. The mannequin device for simulating medical procedures of claim 17, wherein said plurality of color fluids are replaceable.

19. A mannequin device for simulating medical procedures comprising:
a mannequin body;
a plurality of internal cavities;
a plurality of color fluids; and
a plurality of internal components;
wherein said mannequin body covered by a flexible material;
wherein said flexible material surrounding said plurality of internal cavities and said plurality of internal components;
wherein said flexible material is penetrable by a sharp instrument;
wherein said sharp instrument is selected from the group consisting of a needle, a scalpel, and a blade;
wherein said flexible material is self-sealing after removing said sharp instrument; and
further wherein said internal components include a plurality of artificial human organs.

20. The mannequin device for simulating medical procedures of claim 19, wherein said
plurality of color fluids are selectively replenishable.
